(19) United States
(12) Patent Application Publication
(10) Pub. No.: US 2006/0073444 A1
(43) Pub. Date: Apr. 6, 2006

(54) Method of and apparatus for supplementing the reading of selected passages of printed material in a book or the like by voice or acoustic pronouncement of coded indicia provided in the book at such passages, remotely to access the playing of corresponding coded tracks of pre-recorded video/audio supplemental material respectively related to the selected passages

(76) Inventor: Robert H. Rines, Concord, NH (US)

Correspondence Address: RINES & RINES, 81 N. STATE STREET, CONCORD, NH, 03301, US

(21) Appl. No.: 10/948,840

(22) Filed: Sep. 23, 2004

(51) Int. Cl. G09B 5/00

(52) U.S. Cl. 434/169

(57) ABSTRACT

A technique and apparatus for supplementing different subject-matter book passages at the option of the reader with external visual/audio supplementary material on the corresponding respective different subject matters through coded indicia provided at said passages readable and vocally pronounceable by the reader and thereupon remotely received and voice-recognized at a storage-medium visual/audio player, for accessing the playing of such corresponding supplementary visual/audio material from corresponding coded tracks of the medium, controlled by the reader's vocal pronouncement or speaking of the selected respective code indicia in the book.

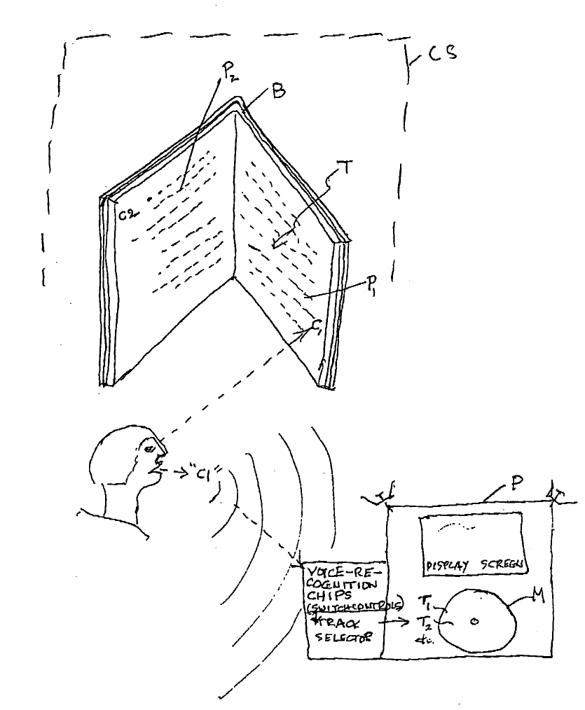

The present invention relates to supplementing the written or printed descriptions read by a reader of books and the like, with video or pictorial screen presentations and illustrations and related displays of supplemental materials that may be viewed by the book reader and that specifically relate to and supplement the specific subject matter of the respective written descriptions or passages on a page or pages—all at the option and will of the reader. The invention is particularly directed to bringing the written words “alive” through enabling contemporaneous viewing of pre-assembled and stored illustrations with or without sound description, such as video, motion picture or other illustrative, pictorial or documentary materials and the like, that can provide a “live” video/audio played-back supplement to the content of the specific passages read by the reader for enriching the reading process. That reading process can then continue after the relevant supplementary material has been accessed and viewed as on a CD or DVD player or the like.

### BACKGROUND

Since the invention of the printing press, for many centuries, books have been published and disseminated with all kinds of illustrations, drawings and even separate supplementary materials. Often books are accompanied by records and tapes and videos which can be supplementary to the material in the text or used in parallel therewith, such as for singing or playing successive songs, the words of which may be in the printed text, or other such interaction or entertainment.

In the computer area, electronic links are provided in the textual electronically printed or displayed written text material or screens for electronically linking to other “pages” of stored material as in the web and otherwise, so that a reader of the screen text can obtain supplementary materials and information, often animated or audibly or visually active.

The problem of the reader associating such supplementary and illustrative and played-back performing materials from stored materials has not, however, heretofore been totally integrated with the text material or the normal reading thereof, or for repeated accessibility and in any order and at any time, and in a user-friendly and flexible manner—all under the reader's control.

It is to these considerations that the present invention, accordingly, is primarily directed; it being conceived that the reader of a book or other textual material may wish readily to access, re-access (and in any order), and view supplemental related subject matter illustrations, photographs, audio and visual supplementary information expanding upon the read passages after or while reading such particular passages of the text. If the reader desires to exercise such an option, the invention enables the reader right then and there, and with immediate association with the textual material that has been read and as to which the reader would like further supplementary related subject-matter visual and audio materials, to depart from the reading of the book and automatically view relevant recorded analog or preferably digital tracks of a CD or DVD or other similar medium that builds upon the written textual passage or portion of the book that has just been read—and to do so at any time and in any accessing order.

This enables much more material to be available than the practical preparation of a book and its printing can accommodate, and, in addition, provides a very inexpensive and potentially large library of such supplementary illustrative materials which just cannot be published in any one book or even collection of books, economically or physically. In preparing a book or a text, furthermore, copious editing is required which is time-consuming and expensive and invariably results in required omissions of materials dictated by the limitations of the production and commercial nature of the book or other publication. The use of DVD, CD or other storage memories, however, is ideal for massive track-coded storage of accumulated supplemental data—photo albums, illustrations, videos, movies, documents, audio and other visual material storage—even in unedited form—which are still extremely interesting to the reader who elects to supplement the reading of specific subject-matter written passages of the text with contemporaneous viewing and hearing of such a collection of subject-matter-related memorabilia and illustrations. The “live” access to the contemporaneous reproducing of such pre-recorded supplemental materials provides an enjoyable addition and informational supplement to the specific material read in the book passage. This then provides an inexpensive and instantly subject-matter accessible coded “album” available to the book purchaser which is not currently available when books are published and distributed for reading.

The invention, furthermore, provides for a very user-friendly and compact supplementary means for the reader to continue in the mode of centuries in picking up a book and reading anywhere at all, but being provided with access to such relevant supplementary stored materials simply by visual code, link or similar representations or indicia printed as in the margin of the book in association with the text passages, or within the text passages themselves if desired, that describe a particular subject matter or events, and from which indicia, the reader can instantly effect access to coded recorded tracks, corresponding to the respective coded indicia, of the conventional CD, DVD player or similar media player and screen, including a laptop or other computer, which the book reader invariably has accessible in the home or other location.

While this invention is particularly useful for the commercial book and related publishing business, the invention is also useful for the family and the amateur wishing to organize all of the photographs, videos, movies and other materials of meaning to the family as a diary or other record of family events for reliving recollections of family history and events. Again, for the use of CD, DVD or other similar coded-track storage of all of the familial photographs and videos, memorabilia and so forth, editing and even chronology are not required. The coded indicia placed, for example, in the margin of the books, diary or other records will be keyed to particular correspondingly coded tracks or areas of the recorded supplementary CD, DVD or other material, which greatly simplifies and obviates the need for indexing and the time and effort involved in the preparation of the same.

While reference has been made herein to “books” or computer or other electronic “screens”, diaries or other physically printed or written or electronically printed and displayed text materials and the like, all such shall be understood to be generically sometimes referred to herein as simply “books” and embraced within that term; similarly, the electronic media for storing and then replaying the relevant stored supplementary material, photographs, documents, audio-video tapes, movies etc. are also hereinafter sometimes generically referred to as supplementary pre-recorded or stored visual or video/audio materials and the like, playable on the reader's laptop or other computer screen or DVD-television screen display or the like, whichever is on-hand where the book reader is located.

A most useful implementation for achieving these novel results is described in my co-pending U.S. application Ser. No. 10/807,894 filed Mar. 24, 2004 for Method Of And Apparatus For Supplementing The Reading of Selected Passages Of Printed Material In A Book Or The Like By Electronically Reading Coded Indicia Provided In The Book At Such Passages To Access The Playing Of Corresponding Coded Tracks Of Pre-Recorded Video/Audio Supplemental Material Respectively Related To The Selected Passages

As this title discloses, the preferred implementation in the above-referenced application requires the book reader to use a coded indicia reader, electronically to scan the indicia in the book and cause the wand with which the electronic code reader is associated, and preferably indeed integrated, remotely to access and activate the appropriate track of the medium player for visual viewing by the book reader. This concept embraces in one of its most general formats, a method of supplementing the materials of various passages of different printed book descriptive materials during a reader's reading of the same, with visual supplemental materials, optionally with audio, correspondingly specifically related to and/or expanding upon the specific subject matter of the various passages of printed descriptive materials, that comprises, electronically storing on tracks of a recorded storage medium, pluralities of such visual supplemental information, each so related specifically to the subject matter of a different corresponding passage of the printed descriptive material in the book, and provided with accessing coding specific to each such track of the medium; printing or otherwise applying and displaying on the pages of the book alongside each of the various descriptive material passages, an electronically readable code indicia corresponding specifically to that coded track of the medium containing the recorded specific visual/audio supplemental material related to the corresponding specific printed descriptive material passage; providing an electronic wand for remotely selectively accessing the respective tracks of a medium player available to the book reader, and controlling the visual/audio playing of the same for displaying/reproducing to the reader said supplemental visual information recorded on the respective tracks; and further providing to the book reader an electronic reader of said coded indicia, adapted to actuate the electronic wand (and, indeed, preferably integrated therein) to play back respective coded tracks of the medium in the player in accordance with the book reader applying the electronic indicia reader to the respective code indicia in the book, thereby to enable the book reader, contemporaneously with reading, to watch/listen to the played-back visual/audio supplemental material and while, if desired, continuing the facility for simultaneously re-reading the corresponding printed passage in the book during, before or after such playback.

The present invention, on the other hand, while achieving the same broad objectives and advantages, does so without requiring either an electronic coded-indicia reader or the wireless electronic wand components or their finctions to access the desired recorded track of the player, as in the above co-pending application,—in fact, requires no auxiliary components whatsoever for the book reader—only the book itself.

This novel result is achieved in the present invention, by applying coded indicia in the book that are visually readable and also are vocally and uniquely pronounceable by the book reader, so as to transmit the vocal acoustical pronouncement of the indicia word(s) or phrases or numbers or sound(s) or combination thereof, for remote reception and recognization by a remote voice-recognition switch controlling the medium player track selection. While I have earlier proposed the use of appropriate voice commands by a vehicle driver, automatically through such voice-recognition switching, selectively to turn on entertainment deck and cell phone instruments in vehicles so as to avoid driver distraction, as, for example, in U.S. Pat. No. 6,002,558, this type of concept, appropriately modified, can now enable a book reader, merely by pronouncing the code word(s) or number or other indicia displayed in the book margin or the like, to cause a remote voice-command recognition switch at the player to access the corresponding recorded coded track and to trigger or control its playing of the selected corresponding supplemental visual material for the reader.

As earlier stated, the use of such remote voice switching relieves the book reader of the necessity for any auxiliary equipment (code indicia reader, remote-control wand) other than the book itself, to access the display of related supplemental material.

### OBJECTS OF INVENTION

An object of the present invention, accordingly, is to provide a new and improved method of and apparatus for providing a book reader with visual material or other supplementation of the book passages in the spirit of said co-pending application, by mere reader voice command—the mere audible pronouncing of coded or selected words or the like (indicia) printed in the book for remote voice-recognition switching control of the selected pre-recorded coded tracks stored at the player for thereupon providing the book reader with the corresponding visual material supplementations afforded by the playing and display of such selected visual materials on the reader's desktop or other computer or TV or other disc player display.

Other and further objects will be explained hereinafter and are more particularly delineated in the appended claims.

### SUMMARY

In summary, from one of its important aspects, accordingly, the invention embraces a method of supplementing the material of various passages on pages of descriptive written materials with corresponding visual and/or audio supplemental materials specifically and respectively related to and/or expanding upon the subject matter of the respective passages, that comprises, recording and storing for playback on a player such supplemental materials and in respective subject-matter corresponding coded tracks; placing on the pages, respective voice-pronounceable coded indicia corresponding to the respective passages in the book, thereby to enable the book reader, contemporaneously with reading, to vocally pronounce selected indicia; remotely recognizing the reader's voice pronouncement at the player to access the corresponding coded track and thereby enable the book reader to watch/listen to the played-back visual/audio supplemental material and while, if desired, continuing the facility for simultaneously re-reading the corresponding printed passage in the book during, before or after such playback.

Preferred and best mode designs and implementation of the invention are later fully detailed.

### DRAWING

The invention will now be described in connection with the accompanying drawing which provides a schematic diagram of a preferred implementation of the invention.

### DESCRIPTION OF PREFERRED EMBODIMENTS

Referring to the drawing, conventional facing pages of a printed book B are shown having textual written or printed portions T that a reader may read in the conventional use of the book. Should the reader desire to see pictures or other visual materials, videos or movies, and/or to hear audio tapes or records, or to see supplementary documents or the like that specifically relate to or supplement specific subject-matter passages or portions of this textual portion T, such as the upper left-hand passages P2 or the lower right-hand passages P1, for example, of specific different respective subject matter, the invention provides for respective coded indicia or markers, C2, C1, etc. in the margins of the book adjacent or near the respective subject matter T passages P2, P1, etc. These coded indicia may be printed or otherwise applied to such margins in accordance with the present invention, and are made not only readable by the reader, but must be vocally pronounceable by the reader, and they are keyed to respective coded tracks T2, T1, etc. of a CD, DVD or the like containing corresponding respective subject-matter supplemented material pre-recorded on a storage medium M, such as on a CD disc or DVD or the like; and the term “indicia” is herein used in a generic sense, also, to embrace symbols, words, numbers, phrases or combinations thereof including words of the selected text passages themselves, if desired.

The disc or other track-coded storage medium is shown within a player P accessible to the book reader and with conventional visual (video)/audio or (sound or acoustic) reproducing and display screens, including computer and television interfacing. The operational actuation of the medium track is effected conventionally, but in accordance with the present invention, under the control of voice-recognition chips at the remote player that receive and recognize the respective reader-spoken words, numbers, phrases, etc. representing the corresponding code indicia in the book as in the margin or, if desired, within the text passage, selected and vocally read off by the book reader. This, in response to the reader's vocally pronounced coded indicia, enables the automatic remote accessing and live playing back of the respective correspondingly coded tracks T1, T2, etc. of the storage medium M in well-known fashion.

Thus, once the book reader has read the particular subject matter of, say, passage P1 and desires to view/hear supplemental visual material as to that specific subject matter—for example, pictures or a video clip with sound—the book reader thereupon reads and speaks out loud the code indicia “C1” printed or otherwise presented near or within the passage P1 and thereby activates the remote voice-recognition switch selection and triggering of the playback on the player P of the corresponding visual/audio supplemental material as to that specific matter described in passage P1 that has been pre-recorded on the corresponding track T1 of the medium M. Similarly, the book reader, having earlier read about different subject matter in written passage P2, may wish to view/hear supplemental material as to that subject matter that has been pre-recorded and stored on corresponding coded track T2 of the medium M. This is effected by the reader audibly pronouncing the coded indicia “C2”. This will be received and voice-recognized at the player to access the corresponding coded track T2 of the medium M on which has been stored the corresponding supplemental material relating to or expanding upon the specific subject matter of the passage P2.

The reader of the book, moreover, may repeatedly thus vocally access such supplemental material, and may access at any time and in any order whatsoever, as desired.

The invention, in summary, thus provides a cooperative method of and apparatus for supplementing the materials of various passages of different printed book descriptive materials P1, P2, etc. during a reader's reading of the same, with visual supplemental materials and optionally with audio, correspondingly specifically related to and/or expanding upon the specific different subject matters of the various different passages P1, P2, etc. of the printed (written) descriptive materials T. As previously described, the electronic prerecording in the storage medium M of corresponding pluralities of such visual supplemental information, each related specifically to the subject matter of a different corresponding passage P1, P2, etc. of the printed descriptive material T in the book B, is stored along correspondingly recorded tracks of the recorded storage medium M—with coding-specific voice-recognition reader-spoken instruction or command-accessing to each such corresponding coded track T1, T2, etc. of the medium M. On the pages of the book alongside our within each of the various descriptive material passages P1, P2, etc., as earlier explained, there has been provided such reader-pronounceable or speakable code indicia C1, C2, etc. corresponding specifically and respectively to the coded tracks T1, T2, etc. of the medium M containing the recorded specific visual supplemental material related to the corresponding specific printed descriptive material passage. The received and recognized reader-spoken voice command codes selectively access the tracks T1, T2, etc. of the playback displayer P and control the visual/audio playing of the same for reproducing and displaying to the book reader the appropriate related supplemental visual information upon the playback displayer, thereby enabling the book reader to watch “live” and listen to the appropriate played-back visual supplemental material. If desired, moreover, the reader may maintain the continued facility for simultaneously re-reading of the corresponding printed passages P1, P2, etc. during, before, or after such playback—all at the option of and under the control of the book reader's voice commands.

As before explained, the underlying concept of the invention is not, however, restricted to the format of a conventional book, as shown for illustrative purposes in printed, handwritten or having other impressed text. A computer or other television or monitor screen format on which the text is electronically printed or displayed on successive screens (pages), schematically indicated in dotted lines as CS, is also a possible “book” format for which the invention is useful.

In practical implementation, suitable voice-command recognition switches and controls may be, for example, of the types described in said U.S. patent and other voice-recognition and responding controls such as effected in ScanSoft Inc. of Peabody Mass. “Dragon-Naturally Speaking” software, version 7.0.

Further modifications will also occur to those skilled in this art and such are considered to fall within the spirit and scope of the invention as defined in the appended claims.

What is claimed is:

1. A method of supplementing the material of various passages on pages of descriptive written materials with corresponding visual and/or audio supplemental materials specifically and respectively related to and/or expanding upon the subject matter of the respective passages, that comprises, recording and storing for playback on a player such supplemental materials and in respective subject-matter coded tracks; placing on the pages, respective voice-pronounceable coded indicia corresponding to the respective passages in the book, thereby to enable the book reader, contemporaneously with reading, vocally to pronounce selected coded indicia; remotely recognizing the reader's voice pronouncement at the player to access the corresponding coded track and thereby enable the book reader to watch/listen to the played-back visual/audio supplemental material and while, if desired, continuing the facility for simultaneously reading or re-reading the corresponding printed passage in the book during, before or after such playback.

2. A method of supplementing the materials of various passages of different printed book descriptive materials during a reader's reading of the same, with visual supplemental materials, and optionally with audio, correspondingly specifically related to and/or expanding upon the specific subject matter of the various passages of printed descriptive materials, that comprises, electronically storing on tracks of a recorded storage medium pluralities of such visual supplemental information, each so related specifically to the subject matter of different corresponding passages of the printed descriptive material in the book, and provided with accessing coding specific to each such track of the medium; printing or otherwise applying and displaying on the pages of the book alongside or within each of the various descriptive material passages, reader readable and vocally pronounceable code indicia corresponding specifically to that coded track of the medium containing the recorded specific visual/audio supplemental material related to the corresponding specific printed descriptive material passage; providing voice-recognizing controls remotely at a medium player for responding to the reader's vocally communicated pronounced code indicia and selectively accessing the respective coded tracks of the medium player available to the book reader, and controlling the visual/audio playing of the same for thereupon displaying/reproducing to the reader said supplemental visual information recorded on the respective tracks, thereby to enable the book reader, contemporaneously with reading, to watch/listen to the played-back visual/audio supplemental material.

3. The method of claim 2 wherein the readable code indicia are applied in the book to one or more of the unprinted margins or spaces of the book pages near the corresponding printed passages, or within the same.

4. The method of claim 2 wherein the book reader's speaking of a selected book coded indicia, communicates with and actuates the voice-recognition control at the player to select and play the respective coded recorded track on the medium corresponding to the book reader's selected book indicia.

5. The method of claim 2 wherein said indicia comprise one more of the group consisting of symbols, words, numbers, and phrases or combinations thereof.

6. The method of claim 5 wherein said indicia are presented in unprinted regions of the book near said corresponding material passages, or within said passages.

7. Apparatus for supplementing the materials of various passages of different printed book descriptive materials during a reader's reading of the same, with visual supplemental materials, optionally with audio, correspondingly specifically related to and/or expanding upon the specific subject matter of the various passages of printed descriptive materials, having, in combination, an electronically recorded storage medium storing tracks of pluralities of such visual supplemental information, each so related specifically to the subject matter of a different corresponding passage of the printed descriptive material in the book, and provided with accessing coding specific to each such track of the medium; reader readable and vocally pronounceable code indicia printed or otherwise applied and displayed on the pages of the book alongside, near or within each of the various descriptive material passages, the indicia corresponding specifically to the corresponding coded track of the medium containing the recorded specific visual/audio supplemental material related to the corresponding specific printed descriptive material passage; voice-recognizing control means remotely at a medium player available to the book reader for responding to the reader's vocally pronounced and communicated code indicia and selectively accessing the respective coded tracks of the medium player, and for controlling the visual/audio playing of the same for thereupon displaying/reproducing to the reader said supplemental visual information recorded on the respective tracks.

8. The apparatus of claim 7 wherein the readable code indicia are applied in the book to the unprinted margins or spaces of the book pages near the corresponding related printed passages, or within the same.

9. The apparatus of claim 7 wherein the book reader's speaking of a selected book coded indicia, communicates and actuates voice-recognition control at the player to select and play the respective recorded track on the medium corresponding to the book reader's selected book indicia.

10. The apparatus of claim 7 wherein the reader-readable and pronounceable coded indicia are selected words, numbers, phrases, sounds, or combinations of the same.

11. The apparatus of claim 7 wherein the readable coded indicia comprise select words, phrases or numbers of the printed passages itself.

12. The apparatus of claim 7 wherein said indicia comprise one more of the group consisting of symbols, words, numbers and phrases or combinations thereof.

13. The apparatus of claim 12 wherein said indicia are presented in unprinted regions of the book near said corresponding material passages or within said passages.

14. Apparatus for supplementing the material of various passages on pages of descriptive written materials with corresponding visual and/or audio supplemental materials specifically and respectively related to and/or expanding upon the subject matter of said passages, that comprises, a recorded storage medium for playback on a player of such supplemental materials stored in respective subject-matter coded tracks; coded indicia, reader-readable and vocally pronounceable, corresponding to said coded tracks of the supplemental recorded materials and placed on the pages near or within the regions of the respective corresponding subject-matter written passages; and voice recognition switch control means at the player for receiving and recognizing the reader-pronounced selected coded indicia provided at the selected passages, automatically to effect actuation of the playback of the player of the supplemental recorded material tracks corresponding to the respective selected indicia and written passages.

15. A method of supplementing the material of various passages on pages of descriptive written materials with corresponding visual and/or audio supplemental materials specifically and respectively related to and/or expanding upon the subject matter of the respective passages, that comprises, recording for playback on a player such supplemental materials and in respective subject-matter coded tracks; placing on the pages, coded indicia corresponding to said coded tracks of the supplemental recorded materials and near or at the regions of the respective corresponding subject-matter written passages; and enabling a reader of the written materials to communicate selected indicia at corresponding selected passages to the player by vocal pronunciation of the selected indicia for remote voice recognition at the player and automatic actuation of the playback of the player of the supplemental recorded material tracks corresponding to the respective selected indicia.
